(19) United States
(12) Patent Application Publication
(10) Pub. No.: US 2005/0209941 A1
(43) Pub. Date: Sep. 22, 2005

(54) Method and system to link demand planning systems with quotation systems

(75) Inventors: Ming Ta Hsu, Jhubei City (TW); Yang Chia-Ho, Hsinchu City (TW)

Correspondence Address: HAYNES AND BOONE, LLP, 901 MAIN STREET, SUITE 3100, DALLAS, TX, 75202, US

(73) Assignee: Taiwan Semiconductor Manufacturing Co., Ltd., Hsin-Chu (TW)

(21) Appl. No.: 10/801,233

(22) Filed: Mar. 16, 2004

(51) Int. Cl. G06F 17/60

(52) U.S. Cl. 705/35; 705/36; 705/1

(57) ABSTRACT

In one embodiment, there is disclosed a computer-implemented method for linking a semiconductor product manufacturing facility demand planning system with a quotation system, the method including updating the quotation system including at least a first raw material product and its quote amount; storing the quote amount associated with the first raw material product; providing the product manufacturing facility demand planning system that identifies at least the first raw material product and desired quantity to produce a finished product; and calculating a demand planning system price associated with the first raw material product by accessing the quote amount associated with the first raw material product from the quotation system, and determining the demand planning system price based on the quote amount associated with the first raw material product and the desired quantity identified in the product manufacturing facility demand planning system.

### TECHNICAL FIELD

The application relates in general to managing semiconductor fabrication facilities, and more specifically to a link between a product manufacturing demand planning system (such as a semiconductor foundry) and a quotation system.

### BACKGROUND

In a semiconductor manufacturing business such as a semiconductor foundry business, one may quote prices to customers based on technologies employed in making devices and based on product options. Technology may be specified by identifying minimum line width (e.g., 0.18 μM), metal composition (e.g., Cu), number of metal layers (e.g., seven metal layers), gate material (e.g., silicide), and other aspects of technology. Product options may include feature inclusion such as circuit probe capability, color filter, bumping, and other product options.

The customer may place an order by identifying a specific device or devices. In this case, the sales administrator taking the order may need to enter the order into the demand planning system, and look up manually the pricing to apply, since there may be no linkage between the demand planning system and the quotation system. This manual procedure takes a lot of time and is subject to error. When errors are made in pricing orders, customers may be displeased.

Accordingly, what is needed is a mechanism and system to link a product manufacturing facility (such as the semiconductor foundry) demand planning system to a price guide/quotation system.

### BRIEF DESCRIPTION OF THE DRAWINGS

FIG. 1 depicts a system for linking a quotation system with a demand planning system.

FIG. 2 depicts a process for updating a quotation system.

FIG. 3 depicts a virtual IC fabrication system.

FIG. 4 depicts a virtual IC fabrication system.

FIG. 5 depicts a computer connected to a network.

FIG. 6 depicts a system for linking a quotation system with a demand planning system.

### DETAILED DESCRIPTION

A method and system is provided for linking a product manufacturing facility (for example, a semiconductor foundry) demand planning system to one or more price guides/quotation systems. It is to be understood that the following disclosure provides many different embodiments, or examples, for implementing different features of the disclosure. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

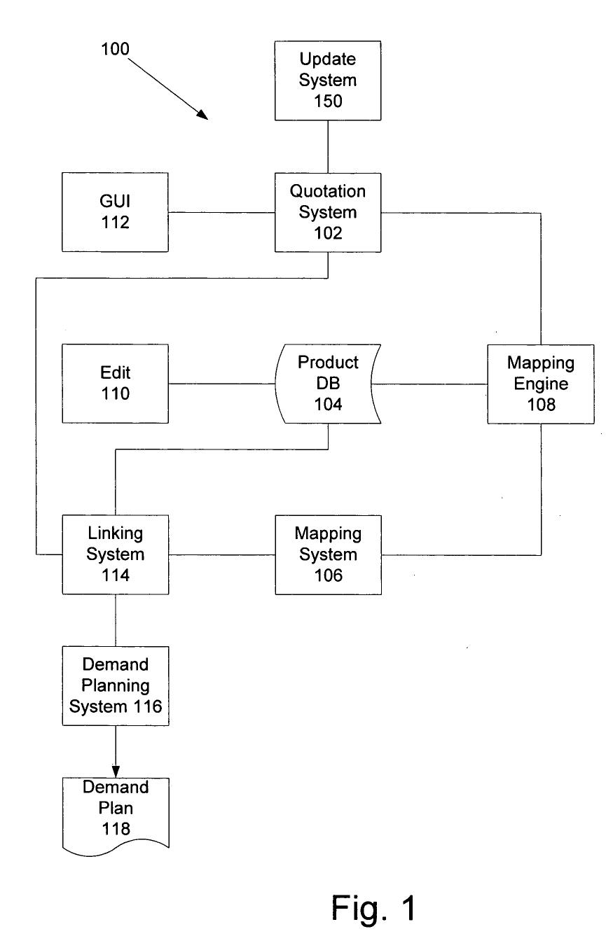

Turning now to FIG. 1, a quotation system-to-demand planning system linking system 100 for linking semiconductor foundry quotation systems with customer demand planning systems is depicted. A quotation system database 102 may store information about prices of raw materials used to make semiconductors in the foundry. In one illustrative embodiment, this information is captured in a raw material item database table. The quotation system raw material item database table has a single record associated with each raw material line item.

In one embodiment, the quotation system raw material database table record format includes the following fields:

| Field Name | Field Purpose |
|---|---|
| Raw material | Identifies a raw material part number, to be matched |
| part number | with the same field in the finished product |
| | database table |
| Quote type | Identifies quotation source from which this raw |
| | material line item came from, for example manual |
| | entry, automated database update, price quote |
| | subscription service, etc. |
| Raw material | Identifies name and description of the raw material |
| description | |
| Raw material price | Price of a unit of the raw material |
| Raw material units | What units are used for the price of the raw material |

In one embodiment, the raw material part number may be used to search through the quotation system raw material database table to find all raw material line items associated with the searched raw material part number.

A product database 104 stores information about products and the technologies on which the product is built. Product database 104 has multiple records associated with each raw material required for each finished product. A single finished product may be associated with multiple raw material item database table records as would be the case if the finished product is composed of multiple raw material line items. In one embodiment, the product database 104 table record format includes the following fields:

| Field Name | Field Purpose |
|---|---|
| Part number | Identifies a specific finished product by part number |
| Finished product | Identifies a specific finished product by name |
| Required raw material part | Identifies a required raw material by part number |
| number | |
| Required raw material name | Identifies a required raw material by name |
| Required raw material amount | Identifies the amount of the raw material required for each |
| | unit of the finished product |
| Raw material units | Identifies the units used to designate the amount of the raw |
| | material needed (for example - grams, milliliters, etc) |
| Reference number of raw | Designates which of the required raw materials this is for the |
| material | particular finished product, if there are multiple raw materials |
| | needed for the finished product. |
| Total number of raw materials | Identifies total number of raw materials needed to produce the |
| needed | finished product, can be combined with the previous field (for |
| | example, raw material 2 of 12 - this record is the second raw |
| | material needed out of a total of 12) |

A mapping system 106 maps information about required raw materials for each finished product from product database 104 with price quotation information for each of those raw materials from quotation database 102. In one embodiment, this information may be captured in another database table, a mapping system database table.

A mapping engine 108 maps changes in both or either the quotation system database 102 or finished product database 104 to update the mapping system database table. This mapping includes accumulating prices associated with each raw material line item associated with a finished product to come up with a total price for each unit of finished product. In FIG. 1, this mapping engine is shown as a separate functional block, but in one embodiment this function may be accomplished by mapping system 106, or by automatic mapping database mechanisms, including database triggers or auto-call functions. Database triggers and/or database auto-call functions have the property of being invoked when specific database tables are modified and of creating a related change in another database table or tables.

A record editing capability 110 communicates with the product database 104, permitting a user to define new finished products and/or new raw material requirements for a finished product in the product database 104. A graphical user interface (GUI) 112 communicates with the quotation system database 102, permitting a user to manually create raw material entries, or update raw material price quotations the quotation system database 102.

A linking system 114 communicates with the mapping system 106, the product database 104, quotation database 102, and demand planning system 116 to create a demand plan 118. Linking system 114 retrieves pending order information from demand planning system 116, and retrieves the required raw materials for each of the finished products in the demand planning system 116 from product database 104. Linking system 114 than associates a price from quotation database 102 for each of the raw materials required for the finished products. Linking system 114 then tabulates a total price for each finished product, and for each order of multiple finished products. The demand planning system 116 permits a user to create the demand plan 118 based on pricing information taken from the quotation database 102, product database 104, and/or mapping system 106.

In one embodiment, demand planning system 116, linking system 114, mapping system 106, product database 104, and quotation database 102 may be encapsulated so as to provide differently privileged users access to different views or layers of the encapsulated database tables. In one embodiment, Siebel Workflow, (Siebel Systems, Inc. of California) may be used to manage some of the databases. In one embodiment, changes to the product database 104 and/or quotation database 102 may be introduced by other business processes independently of the editing functionality 110.

In one embodiment, update system 150 is provided to update pricing information of raw materials in quotation database 102. Update system 150 may be connected to one or more of a subscription pricing service, online databases, pricing reports, and supplier provided pricing information. Update system 150 takes the pricing information from an information source and changes the pricing information for the raw materials in quotation database 102.

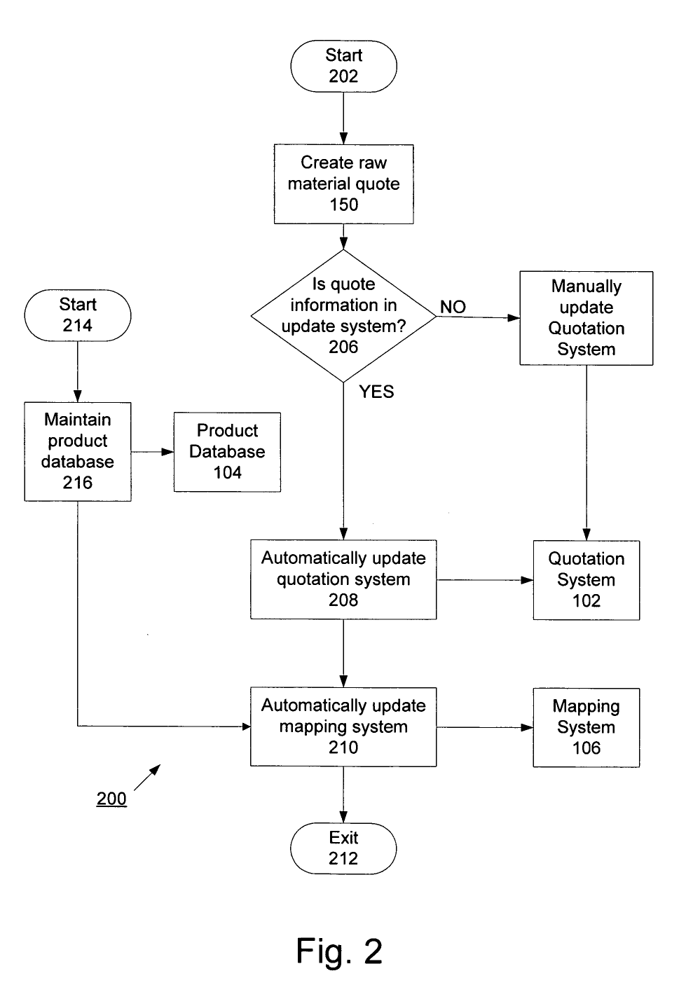

Turning now to FIG. 2, a process 200 for creating a semiconductor quotation system, for updating the quotation system database 102 and for updating the product database 104 is depicted. The process may start at step 202 when the GUI 112 is started and update system 150 is accessed. The process flows to step 204 in which a blank raw material quote is created for each raw material in quotation system database 102. The process flows to step 206 where the blank quote is updated: if pricing information for the raw material is in update system 150, then the quotation system database 102 is automatically updated by update system 150. This automatic update may be effected by a database trigger mechanism or a database auto-call function. If the pricing information for the raw material is not in update system 150, then a user will have to manually update pricing through GUI 112. The process flows to step 210 where the mapping system 106 is automatically updated. This automatic update may be effected by a database trigger mechanism or a database auto-call function. The process flows to step 212 where the process exits. In one embodiment this process may, after step 210, loop back up to step 204 to enable further raw material price quotes to be entered into quotation system 102.

The process may also start at step 214 when the record editing capability 110 session is started. The process flows to step 216 in which the product database 104 is edited to change the finished product information or to add new finished product information, thus updating the product database 104. The process then flows to step 210 where the mapping database 106 is automatically updated. This automatic update may be effected by a database trigger mechanism or a database auto-call function. The process flows to step 212 where the process exits.

The ultimate result of the process 200, starting either from step 202 or step 214, is that quotation system database 102, product database 104, and/or mapping database 106 are updated.

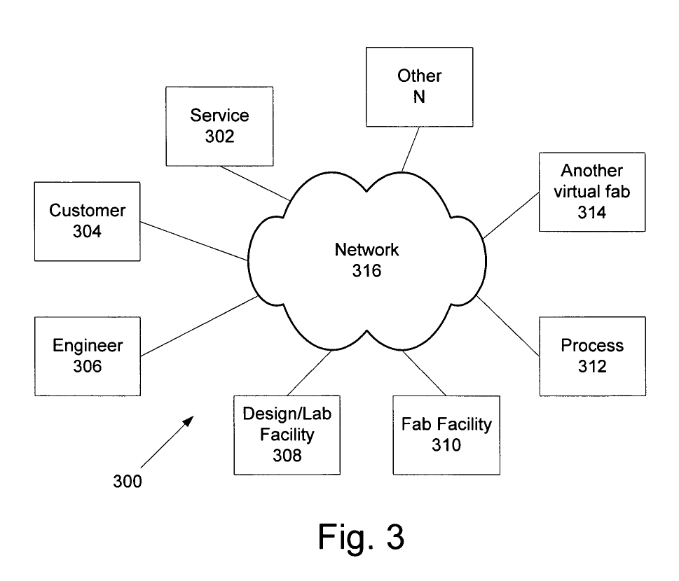

Referring now to FIG. 3, a product manufacturing facility such as virtual IC fabrication system (a “virtual fab”) 300, within which the quotation system-to-demand planning system linking system 100 of FIG. 1 may exist, is illustrated. The virtual fab includes a plurality of entities 302, 304, 306, 308, 310, 312, 314, . . . , N that are connected by a communications network 316. The network 316 may be a single network or may be a variety of different networks, such as an intranet and the Internet, and may include both wireline and wireless communication channels.

In the example virtual fab 300, the entity 302 represents a service system for service collaboration and provision, the entity 304 represents a customer, the entity 306 represents an engineer, the entity 308 represents a design/laboratory (lab) facility for IC design and testing, the entity 310 represents a fabrication (fab) facility, the entity 312 represents a process (e.g., an automated fabrication process), and the entity 314 represents another virtual fab (e.g., a virtual fab belonging to a subsidiary or a business partner). The quotation system-to-demand planning system linking system 100 may be incorporated into one or more of these entities (for example, product database 104 may be populated from fabrication (fab) facility entity 310 or customer 304 may initiate a requested finished product through GUI 114) or be implemented through an individual entity. Each entity may interact with other entities and may provide services to and/or receive services from the other entities.

For purposes of illustration, each entity 302-312 may be referred to as an internal entity (e.g., the engineer 306, or system process 312) that forms a portion of the virtual fab 300 or may be referred to as an external entity (e.g., customer 304) that interacts with the virtual fab 300. Examples of external entities include a customer, a supplier, a design provider; and other facilities that are not directly associated or under the control of the fab. Some entities may be both internal and external. For example, the customer 304 may provide updated mask sets (internal) and may purchase the final product/service (external). Also, it is understood that the entities 302-312 may be concentrated at a single location or may be distributed, and that some entities may be incorporated into other entities. In addition, each entity 302-312 may be associated with system identification information that allows access to information within the system to be controlled based upon authority levels associated with each entities identification information.

The virtual fab 300 enables interaction among the entities 302-312 for the purpose of IC manufacturing, as well as the provision of services. In the present example, IC manufacturing includes receiving the customers' order requirements through the demand planning system in accordance with one embodiment, and the associated operations needed to price and produce the demanded finished products and send them to the customer 304, such as the design, fabrication, testing, and shipping of the ICs.

One of the services provided by the virtual fab 300 may enable collaboration and information access in such areas as design, engineering, and logistics. For example, in the design area, the customer 304 may be given access to information and tools related to the design of their product via the service system 302. The tools may enable the customer 304 to perform yield enhancement analyses, view layout information, and obtain similar information. In the engineering area, the engineer 306 may collaborate with other engineers using fabrication information regarding pilot yield runs, risk analysis, quality, and reliability. The logistics area may provide the customer 304 with fabrication status, testing results, demand planning system handling, and shipping dates. It is understood that these areas are representative, and that more or less information may be made available via the virtual fab 300 as desired.

Another service provided by the virtual fab 300 may be to integrate systems between facilities, such as between the design/lab facility 308 and the fab facility 310. Such integration enables facilities to coordinate their activities. For example, integrating the design/lab facility 308 and the fab facility 310 may enable design information to be incorporated more efficiently into the fabrication process, and may enable data from the fabrication process to be returned to the design/lab facility 310 for evaluation and incorporation into later versions of an IC. The process 312 may represent any process operating within the virtual fab 300.

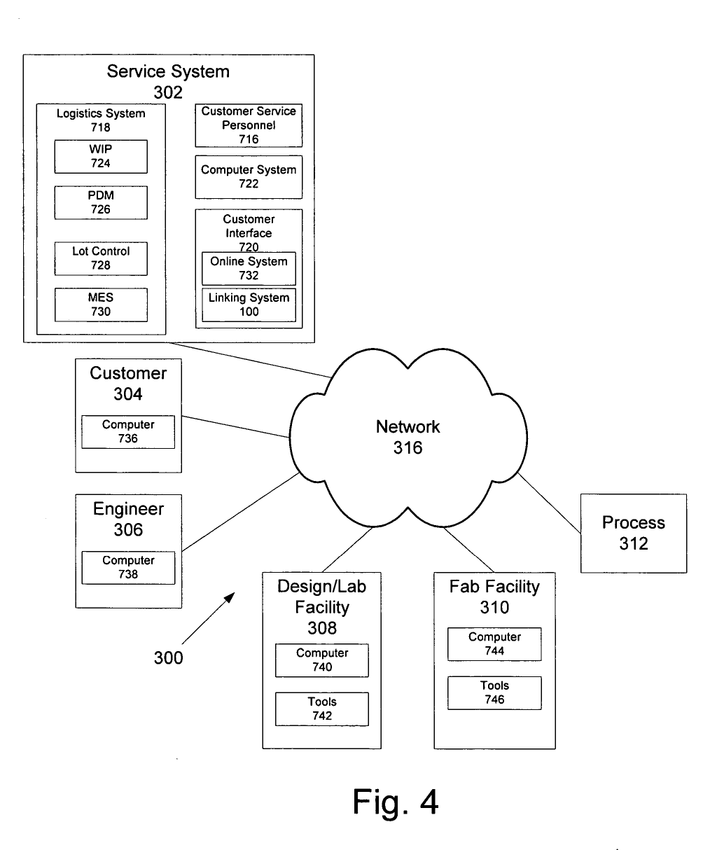

Referring now to FIG. 4, in another embodiment of the virtual fab 300, the entities 302-312 are described with greater details. The service system 302 provides an interface between the customer and the IC manufacturing operations. For example, the service system 302 may include customer service personnel 716, a logistics system 718 for order handling and tracking, a customer interface 720 for enabling a customer to directly access various aspects of an order, and a computer system 722.

The logistics system 718 may include a work-in-process (WIP) inventory system 724, a product data management system 726, a lot control system 728, and a manufacturing execution system (MES) 730. The WIP inventory system 724 may track working lots using a database. The product data management system 726 may manage product data and maintain product information such as quotation system 102, update system 150, product database 104, and mapping system 106 (see FIG. 1).

The MES 730 may be an integrated computer system representing the methods and tools used to accomplish production. In the present example, the primary functions of the MES 730 may include collecting data in real time, organizing and storing the data in a centralized database, work demand planning system management, workstation management, process management, inventory tracking, and document control. The MES 730 may be connected to other systems both within the service system 302 and outside of the service system 302. Examples of products suitable for MES 730 include Promis (Brooks Automation Inc. of Massachusetts), Workstream (Applied Materials, Inc. of California), Poseidon (IBM Corporation of New York), and Mirl-MES (Mechanical Industry Research Laboratories of Taiwan). Each MES may have a different application area. For example, Mirl-MES may be used in applications involving packaging, liquid crystal displays (LCDs), and printed circuit boards (PCBs), while Promis, Workstream, and Poseidon may be used for IC fabrication and thin film transistor LCD (TFT-LCD) applications. The MES 730 may include such information as a process step sequence for each product.

The customer interface 720 may include an online system 732 and the quotation system-to-demand planning linking system 100 (or portions thereof). The online system 732 may function as an interface to communicate with the customer 304, other systems within the service system 302, supporting databases (not shown), and other entities 306-312. The demand planning system (not shown) may manage customer demand planning through linking system 114 and may be associated with another supporting database (not shown) to maintain client information.

Portions of the service system 302, such as the customer interface 720 and/or the quotation system-to-demand planning linking system 100, may be associated with a computer system 722. In some embodiments, the computer system 722 may include multiple computers, some of which may operate as servers to provide services to the customer 304 or other entities. The service system 302 may also provide such services as identification validation and access control, both to prevent unauthorized users from accessing data and to ensure that an authorized customer can access only their own data.

The customer 304 may obtain information about the manufacturing of its ICs via the virtual fab 700 using a computer system 736. In the present example, the customer 304 may access the various entities 302, 306-312 of the virtual fab 300 through the customer interface 720 provided by the service system 302. However, in some situations, it may be desirable to enable the customer 304 to access other entities without going through the customer interface 720. For example, the customer 304 may directly access the fab facility 310 to obtain fabrication related data.

The engineer 306 may collaborate in the IC manufacturing process with other entities of the virtual fab 300 using a computer system 738. The virtual fab 300 enables the engineer 306 to collaborate with other engineers and the design/lab facility 308 in IC design and testing, to monitor fabrication processes at the fab facility 310, and to obtain information regarding test runs, yields, etc. In some embodiments, the engineer 306 may communicate directly with the customer 304 via the virtual fab 300 to address design issues and other concerns.

The design/lab facility 308 provides IC design and testing services that may be accessed by other entities via the virtual fab 300. The design/lab facility 308 may include a computer system 740 and various IC design and testing tools 742. The IC design and testing tools 742 may include both software and hardware.

The fab facility 310 enables the fabrication of ICs. Control of various aspects of the fabrication process, as well as data collected during the fabrication process, may be accessed via the virtual fab 300. The fab facility 310 may include a computer system 744 and various fabrication hardware and software tools and equipment 746. For example, the fab facility 310 may include conventional fabrication tools, for example, an ion implantation tool, a chemical vapor deposition tool, a thermal oxidation tool, a sputtering tool, and various optical imaging systems, as well as the software needed to control these components.

The process 312 may represent any process or operation that occurs within the virtual fab 300. For example, the process 312 may be the quotation system process, a fabrication process that runs within the fab facility 310, a design process executed by the engineer 306 using the design/lab facility 308, or a communications protocol that facilities communications between the various entities 302-312.

It is understood that the entities 302-312 of the virtual fab 300, as well as their described interconnections, are for purposes of illustration only. For example, it is envisioned that more or fewer entities, both internal and external, may exist within the virtual fab 300, and that some entities may be incorporated into other entities or distributed. For example, the service system 302 may be distributed among the various entities 306-310.

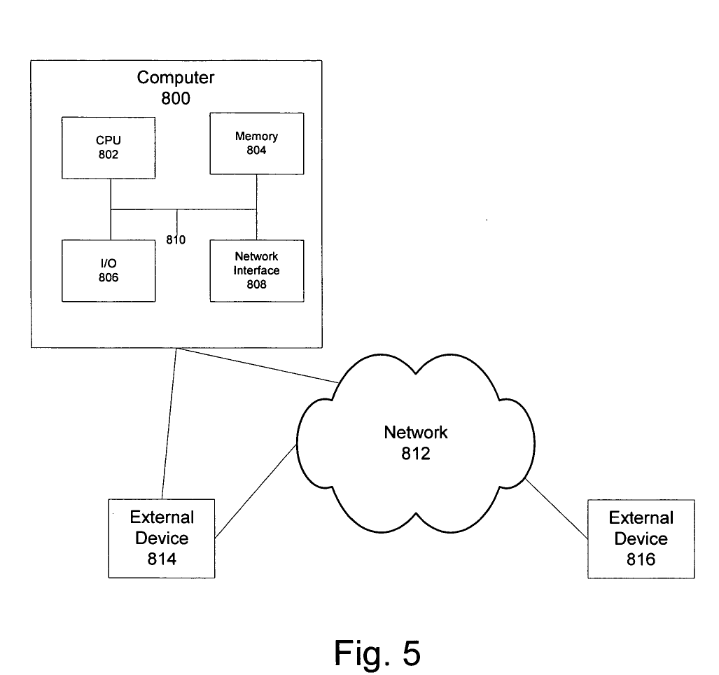

Referring now to FIG. 5, an example computer 800 may be used to implement one or more portions of the present embodiments, including the implementation of the quotation system-to-demand planning linking system 100 within the virtual fab 300 of FIG. 3. The computer 800 may include a central processing unit (CPU) 802, a memory unit 804, an input/output (I/O) device 806, and a network interface 808. The network interface may be, for example, one or more network interface cards (NICs). The components 802, 804, 806, and 808 are interconnected by a bus system 810. It is understood that the computer 800 may be any processing device (for example, a stand alone computer, a network of computers, a personal data assistant, etc.) and may be differently configured and that each of the listed components may actually represent several different components. For example, the CPU 802 may actually represent a multi-processor or a distributed processing system; the memory unit 804 may include different levels of cache memory, main memory, hard disks, and remote storage locations; and the I/O device 806 may include monitors, keyboards, and the like.

The computer 800 may be connected to a network 812, which may be connected to the networks 316 (FIGS. 3, 4). The network 812 may be, for example, a complete network or a subnet of a local area network, a company wide intranet, and/or the Internet. The computer 800 may be identified on the network 812 by an address or a combination of addresses, such as a media control access (MAC) address associated with the network interface 808 and an internet protocol (IP) address. Because the computer 800 may be connected to the network 812, certain components may, at times, be shared with other devices 814, 816. Therefore, a wide range of flexibility is anticipated in the configuration of the computer. Furthermore, it is understood that, in some implementations, the computer 800 may act as a server to other devices 814, 816. The devices 814, 816 may be computers, personal data assistants, wired or cellular telephones, or any other device able to communicate with the computer 800.

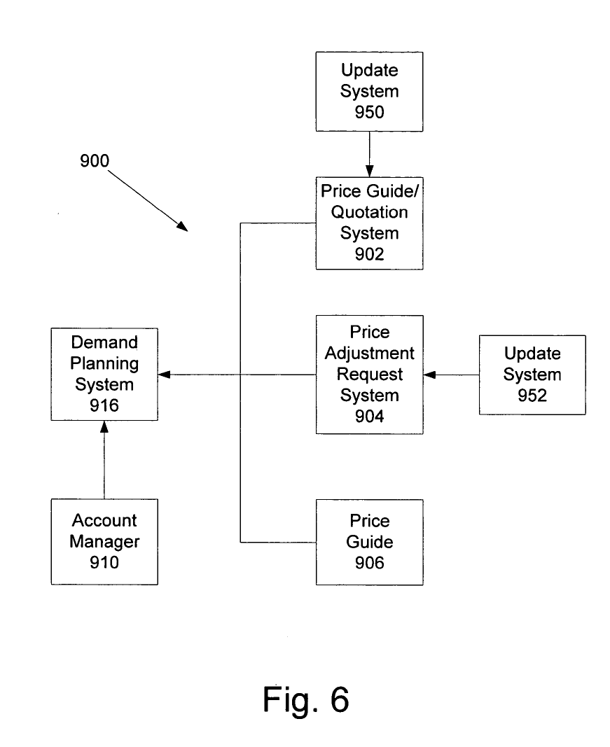

Referring now to FIG. 6, in another embodiment, there is illustrated system 900 to incorporate pricing data into demand planning system 916. Pricing data may be imported into demand planning system 916 from price guide/quotation system 902. Price guide/quotation system 902 is updated by update system 950. Update system 950 may perform automatic pricing updates from subscription services or suppliers, and/or may involve manual updating of pricing data in price guide/quotation system 902.

Pricing data may also be imported into demand planning system 916 from price adjustment request (PAR) system 904. Price adjustment request system is updated by update system 952. Update system 952 may be automatically updated by supplier upload and/or manually updated by suppliers, subscription services, third-party providers, and/or by the operator of system 900.

Pricing data may also be imported into demand planning system 916 from price guide 906. Price guide 906 may be, for example, an online catalog or database of semiconductor fabrication raw material prices.

In one embodiment, account manager 910 is also able to override pricing sources 902, 904 and 906 if another pricing level is preferred.

In another embodiment, a forecast price rule for use with demand planning system 916 is defined as: first, attempt to access pricing information from price guide/quotation system 902; second, if price guide/quotation system 902 does not have pricing information, then access pricing information from price adjustment request system 904; third, if neither price guide/quotation system 902 nor price adjustment request system 904 have pricing information, then access pricing information from price guide 906.

In another embodiment, a method of importing pricing information into demand planning system 916 includes: attempting to access pricing information from price guide/quotation system 902; if price guide/quotation system 902 does not have pricing information, then attempting to access pricing information from price adjustment request system 904; and if neither price guide/quotation system 902 nor price adjustment request system 904 have pricing information, then attempting to access pricing information from price guide 906.

In one embodiment, there is disclosed a computer-implemented method for linking a semiconductor product manufacturing facility demand planning system with a quotation system, the method including updating the quotation system including at least a first raw material product and its quote amount; storing the quote amount associated with the first raw material product; providing the product manufacturing facility demand planning system that identifies at least the first raw material product and desired quantity to produce a finished product; and calculating a demand planning system price associated with the first raw material product by accessing the quote amount associated with the first raw material product from the quotation system, and determining the demand planning system price based on the quote amount associated with the first raw material product and the desired quantity identified in the product manufacturing facility demand planning system. In another embodiment, the product manufacturing facility is a semiconductor foundry. In another embodiment, the quote amount is stored in a quotation system database. In another embodiment, the method also includes storing information associated with the first raw material product in a product database. In another embodiment, the method also includes updating a mapping system with information from the quotation system database and the product database associated with the first raw material product. In another embodiment, the mapping database is updated automatically when the quotation system database is changed. In another embodiment, the mapping database is updated automatically when a new quotation is entered into the quotation system database utilizing a database trigger. In another embodiment, the mapping database is updated automatically when a new quotation is entered into the quotation system database utilizing a auto-call function. In another embodiment, the mapping database is updated automatically when the product database is changed. In another embodiment, the method also includes receiving a quote amount for a second raw material product; storing the quote amount associated with the second raw material product; and calculating a demand planning system price associated with the second raw material product, wherein the demand planning system identifies at least the first raw material product and the second raw material product prices and desired respective quantities, by accessing the stored quote amount associated with the second raw material product, and determining the demand planning system price for the second raw material product based on the stored quote amount associated with the second raw material product and the desired quantity identified in the product manufacturing facility demand planning system. In another embodiment, the quote amount associated with the first raw material product and the quote amount associated with the second raw material product are in the same quotation system.

In one embodiment, there is disclosed a computer-implemented method for linking a semiconductor product manufacturing facility demand planning system with a quotation system, the method including providing the quotation system with at least two raw material products and their respective quote amounts; storing the two quote amounts; providing the product manufacturing facility demand planning system that identifies at least the two raw material products and their respective desired quantities; and calculating demand planning system prices associated with the at least two raw material products by accessing the quote amounts associated with the products, and determining the demand planning system prices based on the respective quote amounts associated with the products and their respective desired quantities identified in the product manufacturing facility demand planning system. In another embodiment, the product manufacturing facility is a semiconductor foundry. In another embodiment, the quote amounts are stored in respective quotation system database records in a quotation system database. In another embodiment, the method also includes storing predetermined information associated with the first raw material product and second raw material product in respective raw material product database records. In another embodiment, the quotation system database is updated automatically when the quote amount is changed. In another embodiment, the facility demand planning system is updated automatically when the quote amount is changed. In another embodiment, the facility demand planning system is updated automatically when the quotation system database is updated.

In one embodiment, there is disclosed a computer-readable medium having stored thereon sequences of instruction for responding to a request for linking a semiconductor product manufacturing facility demand planning system with a quotation system, the sequence of instructions including instructions for performing the steps including providing the quotation system including at least a first raw material product and its quote amount; storing the quote amount; providing the product manufacturing facility demand planning system that identifies at least the first product and desired quantity; and calculating a demand planning system price associated with the first raw material product by accessing the quote amount associated with the first raw material product, and determining the demand planning system price based on the quote amount associated with the first raw material product and the quantity required by the product manufacturing facility demand planning system to manufacture a finished product. In another embodiment, the product manufacturing facility is a semiconductor foundry. In another embodiment, the sequence of instructions further comprises instructions for performing the steps including storing the quotation system amount in a quotation system database. In another embodiment, the medium also includes storing predetermined information associated with the first raw material product in a product database.

In one embodiment, there is disclosed a system for linking a product manufacturing facility demand planning system with a quotation system, the system including a quotation system entry device for entering a quotation entry that includes at least two raw materials and their quote amounts; memory connected to the data entry device configured to receive the quote amounts; a demand planning system entry device for entering a finished product and required raw material products and desired quantities; and a price calculator configured to receive the desired quantities of raw materials from the demand planning system entry device, to access the memory to identify the quote amounts associated with the raw materials, and to calculate a price for the finished product based on the desired quantities and quote amounts of raw materials. In another embodiment, the product manufacturing facility is a semiconductor foundry. In another embodiment, the memory includes a quotation system database connected to the demand planning system entry device; a product database configured to receive raw material product information; and a mapping database that interfaces with both the quotation system database and product database capable of storing information associated with the raw material products. In another embodiment, the quotation system database additionally includes an automatic updating mapping database mechanism which updates the mapping database when the quotation system database is changed. In another embodiment, the product database additionally includes an automatic updating mapping database mechanism which updates the mapping database when the product database is changed. In another embodiment, the quotation system entry device and the demand planning system entry device include a single device. In another embodiment, the single device is a personal data assistant. In another embodiment, the quotation system entry device is connected to the memory via a wireless connection. In another embodiment, the demand planning system entry device is connected to the price calculator via a wireless connection.

Although only a few example embodiments have been described in detail above, those skilled in the art will readily appreciate that many modifications are possible in the example embodiments. Accordingly, all such modifications are intended to be included in the scope of this disclosure as defined in the following claims. In the claims, means-plus-function clauses are intended to cover the structures described herein as performing the recited function and not only structural equivalents, but also equivalent structures.

1. A computer-implemented method for linking a semiconductor product manufacturing facility demand planning system with a quotation system, the method comprising:
updating the quotation system including at least a first raw material product and its quote amount;
storing the quote amount associated with the first raw material product;
providing the product manufacturing facility demand planning system that identifies at least the first raw material product and desired quantity to produce a finished product; and
calculating a demand planning system price associated with the first raw material product by
accessing the quote amount associated with the first raw material product from the quotation system, and
determining the demand planning system price based on the quote amount associated with the first raw material product and the desired quantity identified in the product manufacturing facility demand planning system.

2. The computer-implemented method of claim 1 wherein the product manufacturing facility demand planning system comprises a semiconductor foundry.

3. The computer-implemented method of claim 1 wherein the quote amount is stored in a quotation system database.

4. The computer-implemented method of claim 3, further comprising:
storing information associated with the first raw material product in a product database.

5. The computer-implemented method of claim 4, further comprising:
updating a mapping system with information from the quotation system database and the product database associated with the first raw material product.

6. The computer-implemented method of claim 5, wherein the mapping database is updated automatically when the quotation system database is changed.

7. The computer-implemented method of claim 5, wherein the mapping database is updated automatically when a new quotation is entered into the quotation system database utilizing a database trigger.

8. The computer-implemented method of claim 5, wherein the mapping database is updated automatically when a new quotation is entered into the quotation system database utilizing a auto-call function.

9. The computer-implemented method of claim 5, wherein the mapping database is updated automatically when the product database is changed.

10. The computer-implemented method of claim 1, further comprising:
receiving a quote amount for a second raw material product;
storing the quote amount associated with the second raw material product; and
calculating a demand planning system price associated with the second raw material product, wherein the demand planning system identifies at least the first raw material product and the second raw material product prices and desired respective quantities, by
accessing the stored quote amount associated with the second raw material product, and
determining the demand planning system price for the second raw material product based on the stored quote amount associated with the second raw material product and the desired quantity identified in the product manufacturing facility demand planning system.

11. The computer-implemented method of claim 10, wherein the quote amount associated with the first raw material product and the quote amount associated with the second raw material product are in the same quotation system.

12. A computer-implemented method for linking a semiconductor product manufacturing facility demand planning system with a quotation system, the method comprising:
providing the quotation system with at least two raw material products and their respective quote amounts;
storing the two quote amounts;
providing the product manufacturing facility demand planning system that identifies at least the two raw material products and their respective desired quantities; and
calculating demand planning system prices associated with the at least two raw material products by
accessing the quote amounts associated with the products, and
determining the demand planning system prices based on the respective quote amounts associated with the products and their respective desired quantities identified in the product manufacturing facility demand planning system.

13. The computer-implemented method of claim 12, wherein the product manufacturing facility is a semiconductor foundry.

14. The computer-implemented method of claim 12, wherein the quote amounts are stored in respective quotation system database records in a quotation system database.

15. The computer-implemented method of claim 14, further comprising:
storing predetermined information associated with the first raw material product and second raw material product in respective raw material product database records.

16. The computer-implemented method of claim 15, wherein the quotation system database is updated automatically when the quote amount is changed.

17. The computer-implemented method of claim 15, wherein the facility demand planning system is updated automatically when the quote amount is changed.

18. The computer-implemented method of claim 15, wherein the facility demand planning system is updated automatically when the quotation system database is updated.

19. A computer-readable medium having stored thereon sequences of instruction for responding to a request for linking a semiconductor product manufacturing facility demand planning system with a quotation system, the sequence of instructions including instructions for performing the steps of:
providing the quotation system including at least a first raw material product and its quote amount;
storing the quote amount;
providing the product manufacturing facility demand planning system that identifies at least the first product and desired quantity; and
calculating a demand planning system price associated with the first raw material product by
accessing the quote amount associated with the first raw material product, and
determining the demand planning system price based on the quote amount associated with the first raw material product and the quantity required by the product manufacturing facility demand planning system to manufacture a finished product.

20. The computer-readable medium of claim 19, wherein the product manufacturing facility is a semiconductor foundry.

21. The computer-readable medium of claim 19, wherein the sequence of instructions further comprises instructions for performing the steps of:
storing the quotation system amount in a quotation system database.

22. The computer-readable medium of claim 21, the sequence of instructions further comprises instructions for performing the steps of:
storing predetermined information associated with the first raw material product in a product database.

23. A system for linking a product manufacturing facility demand planning system with a quotation system, the system comprising:
a quotation system entry device for entering a quotation entry that includes at least two raw materials and their quote amounts;
memory connected to the data entry device configured to receive the quote amounts;
a demand planning system entry device for entering a finished product and required raw material products and desired quantities; and
a price calculator configured to receive the desired quantities of raw materials from the demand planning system entry device, to access the memory to identify the quote amounts associated with the raw materials, and to calculate a price for the finished product based on the desired quantities and quote amounts of raw materials.

27. The system of claim 26, wherein the product manufacturing facility is a semiconductor foundry.

28. The system of claim 26, wherein the memory comprises
a quotation system database connected to the demand planning system entry device;
a product database configured to receive raw material product information; and
a mapping database that interfaces with both the quotation system database and product database capable of storing information associated with the raw material products.

29. The system of claim 28, wherein the quotation system database additionally comprises
an automatic updating mapping database mechanism which updates the mapping database when the quotation system database is changed.

30. The system of claim 28, wherein the product database additionally comprises
an automatic updating mapping database mechanism which updates the mapping database when the product database is changed.

31. The system of claim 26, wherein the quotation system entry device and the demand planning system entry device comprise a single device.

32. The system of claim 31, wherein the single device is a personal data assistant.

33. The system of claim 26, wherein the quotation system entry device is connected to the memory via a wireless connection.

34. The system of claim 26, wherein the demand planning system entry device is connected to the price calculator via a wireless connection.
